(19) United States
(12) Patent Application Publication
(10) Pub. No.: US 2023/0186417 A1
(43) Pub. Date: Jun. 15, 2023

(54) APPARATUS AND METHODS FOR MONITORING A DIGITAL ASSET ASSOCIATED WITH A DISTRIBUTED LEDGER

(71) Applicant: Safe And Fair Enforcement Inc. d/b/a SAFE, Inc., Rockville, MD (US)

(72) Inventor: Thomas Luginbill, Rockville, MD (US)

(73) Assignee: Safe And Fair Enforcement Inc. d/b/a SAFE, Inc., Rockville, MD (US)

(21) Appl. No.: 18/080,077

(22) Filed: Dec. 13, 2022

Related U.S. Application Data
(60) Provisional application No. 63/289,530, filed on Dec. 14, 2021.

(51) Int. Cl. G06Q 50/18; G06Q 20/38

(52) U.S. Cl. CPC G06Q 50/184; G06Q 20/389

(57) ABSTRACT

Methods, systems, and apparatuses to monitor and track a usage of a digital asset by one or more third party users. The digital asset may be associated with a digital token of a distributed ledger. Further, metric data identifying and characterizing the monitored and tracked usage of the digital asset may be recorded within at least an element of the distributed ledger.

### CROSS-REFERENCE TO RELATED APPLICATION

This application claims the benefit of priority to U.S. Provisional Patent Application No. 63/289,530, filed on Dec. 14, 2021. The disclosures of the provisional application are expressly incorporated herein by reference to its entirety.

### FIELD OF DISCLOSURE

The disclosed embodiments generally relate to computer-implemented systems and processes that monitor one or more digital assets of distributed ledgers.

### BACKGROUND

In some examples, a digital service provider (DSP) computing system may provide various digital content, such as audio content and/or video content, to various users via a computing device operated by a corresponding user. Additionally, the DSP computing system may monitor the usage of the various digital content and generate and determine metrics and analytics associated with the usage of the various digital content by the various users of the DSP computing system. However, the DSP computing system is not configured to communicate with distributed ledgers of digital asset owners and vice versa. As such, the DSP computing system is not able to track or monitor usage of content of a digital asset of a digital token included in a distributed ledger of the digital asset owner, and the distributed ledger of the digital asset owner is not configured to monitor and record usage information, associated with the usage, by DSP computing system users, of the content of the digital asset of the digital token, onto the distributed ledger. As described herein, the inventors have identified and developed technical solutions to resolve these technical problems.

### SUMMARY

According to one aspect, an apparatus may comprise a non-transitory, machine-readable storage medium storing instructions, and at least one processor coupled to the non-transitory machine-readable storage medium. The at least one processor may be configured to receive, from a first device via the communications interface, a request to generate an identifier associated with a digital token. In some examples, the digital token is associated with an immutable digital asset and an immutable smart contract object of a distributed ledger. Additionally, the at least one processor may be configured to, based on the request, and confirmation that the request was made by or for an owner of the digital asset, generate and transmit, via the communications interface and to a first computing system, the identifier. Moreover, the at least one processor may be configured to receive, via the communications interface and from the first computing system, a message including the identifier and metric data associated with the digital asset. In some examples, the metric data identifies and characterizes one or more metrics associated with one or more interactions of the digital asset by one or more additional devices via the first computing system. Further, the at least one processor may be configured to, based at least on the identifier included in the message, transmit, via the communications interface and to the first device, the metric data, and cause a first application program executing on the first device to record, within at least a first element of the distributed ledger, an object that includes one or more portions of the metric data.

According to another aspect, a non-transitory, machine-readable storage medium storing instructions that, when executed by at least one processor of a server, may cause the at least one processor to perform operations that include receiving, from a first device, a request to generate an identifier associated with a digital token. In some examples, the digital token is associated with an immutable digital asset and an immutable smart contract object of a distributed ledger. Additionally, the at least one processor may perform operations that include, based on the request, and confirmation that the request was made by or for an owner of the digital asset, generating and transmitting, to a first computing system, the identifier. Moreover, the at least one processor may perform operations that include receiving, from the first computing system, a message including the identifier and metric data associated with the digital asset. In some examples, the metric data identifies and characterizes one or more metrics associated with one or more interactions of the digital asset by one or more additional devices via the first computing system. Further, the at least one processor may perform operations that include, based at least on the identifier included in the message, transmitting, to the first device, the metric data, and causing a first application program executing on the first device to record, within at least a first element of the distributed ledger, an object that includes one or more portions of the metric data.

According to another aspect, a method may include receiving, from a first device, a request to generate an identifier associated with a digital token. In some examples, the digital token is associated with an immutable digital asset and an immutable smart contract object of a distributed ledger. Additionally, the method may include, based on the request, and confirmation that the request was made by or for an owner of the digital asset, generating and transmitting, to a first computing system, the identifier. Moreover, the method may include receiving, from the first computing system, a message including the identifier and metric data associated with the digital asset. In some examples, the metric data identifies and characterizes one or more metrics associated with one or more interactions of the digital asset by one or more additional devices via the first computing system. Further, the method may include, based at least on the identifier included in the message, transmitting, to the first device, the metric data, and causing a first application program executing on the first device to record, within at least a first element of the distributed ledger, an object that includes one or more portions of the metric data.

### BRIEF DESCRIPTION OF THE DRAWINGS

FIG. 1 is a block diagram of an exemplary computing environment, in accordance with some exemplary embodiments;

FIGS. 2A-2C are block diagrams illustrating a portion of an exemplary computing environment, in accordance with some exemplary embodiments;

FIG. 3 is a block diagram illustrating a portion of an exemplary computing environment, in accordance with some exemplary embodiments;

FIGS. 4A-4B are block diagrams illustrating a portion of an exemplary computing environment, in accordance with some exemplary embodiments;

FIG. 5 is a block diagram illustrating a portion of an exemplary computing environment, in accordance with some exemplary embodiments;

FIGS. 6A-6C are block diagrams illustrating a portion of an exemplary computing environment, in accordance with some exemplary embodiments; and

FIG. 7 is a flowchart of an exemplary process 700 for monitoring a digital asset associated with a distributed ledger.

Like reference numbers and designations in the various drawings indicate like elements.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to a computing environment that includes a computing system that may coordinate communications between a distributed ledger of a user and another computing system, such as a digital service provider (DSP) configured to provide content of one or more digital assets of the distributed ledger to one or more other or third party users. Additionally, the computing system may be configured to obtain information, such as metrics and analytics, related to the usage or interactions of the digital asset of the digital token, by the one or more other or third party users, and coordinate the recording of such information onto the distributed ledger of the user. In some instances, the computing system may be configured to cause the computing device of a user to present a graphical representation of at least one of the metrics and analytics within a digital interface.

### A. Exemplary Computing Environments

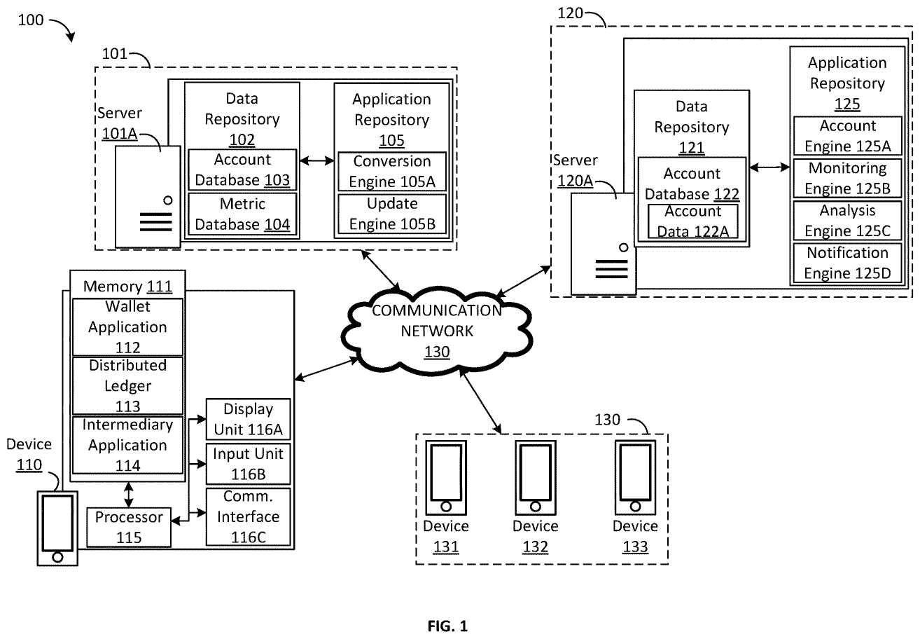

FIG. 1 illustrates a block diagram of an example computing environment 100 that includes, among other things, one or more computing systems, such as intermediary computing system 101 and digital service provider (DSP) computing system 120, and one or more devices including one or more client devices 110, such as one or more client device 110 and one or more third party devices 130, such as third party device 131, third party device 132, third party device 133. Each of the one or more computing systems, such as intermediary computing system 101 and DSP computing system 120, the one or more client devices, and the one or more third party devices 130 may each be operatively connected to, and interconnected across, one or more communications networks, such as communications network 140. Examples of communications network 140 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the devices and systems operating within computing environment 100 may perform operations that establish and maintain one or more secure channels of communication across communications network 140, such as, but not limited to, a transport layer security (TLS) channel, a secure socket layer (SSL) channel, or any other suitable secure communication channel.

The one or more client devices, such as client device 110, may each have one or more tangible, non-transitory memories, such as memory 111, that store data and/or software instructions, and one or more processors (e.g., processor 115), configured to execute the software instructions. The one or more tangible, non-transitory memories may, in some aspects, store application programs, application engines or modules, and other elements of code executable by the one or more processors. As illustrated in FIG. 1, client device 110 may store within the one or more tangible, non-transitory memories, an executable wallet application 112, which may be provisioned to client device 110. In some instances, the wallet application may be supported by a centralized computing system, such as a centralized wallet computing system (e.g., not illustrated in FIG. 1). In other instances, the wallet application may be supported by a decentralized computing system, such as multiple computing devices, servers and/or computing systems. In various instances, and upon execution by the one or more processors of client device 110, the wallet application may perform any of the exemplary processes described herein to, among other things, access and obtain data from one or more portions of a distributed ledger, such as distributed ledger 113 of a user operating client device 110 and request a recordation of data within one or more portions of the distributed ledger, such as distributed ledger 113. In such instances, and as described herein, the distributed ledger may include elements that maintain a cryptographically secure and immutable record of the user, such as the user operating client device 110. The elements of the distributed ledger, such as distributed ledger 113, may also establish and maintain a cryptographically secure, immutable, and time-evolving record of digital assets transferred to, and received from, counterparties through peer-to-peer transactions.

In various instances, not illustrated in FIG. 1, the tangible, non-transitory memories, such as memory 111, of each of the one or more client devices, such as client device 110, may include one or more structured or unstructured data repositories or databases. Additionally, the tangible, non-transitory memories of each of the one or more client devices may maintain one or more elements of device data within the one or more structured or unstructured data repositories or databases. For example, the elements of device data may uniquely identify the corresponding client device within computing environment 100, and may include, but are not limited to, an Internet Protocol (IP) address assigned to the corresponding client device or a media access control (MAC) layer assigned to the corresponding client device.

In some instances, the one or more client devices, such as client device 110 and other components (e.g., other computing systems and devices) in the computing environment 100 (not illustrated in FIG. 1) may collectively form a portion of a distributed ledger network. Additionally, each of the other components and the one or more client devices may maintain a local version of the distributed ledger, such as the distributed ledger 113, within a corresponding tangible, non-transitory memory. Moreover, the one or more client devices, may establish, maintain, or update the distributed ledger of the user, such as the distributed ledger 113 of the user operating client device 110, using among other things, one or more consensus-based processes, and may broadcast updated versions of the distributed ledger across communications network 140 to the other components and the other client devices of the distributed ledger network. In various instances, the one or more client devices, such as client device 110, may perform operations that establish, maintain, or update the distributed ledger, such as distributed ledger 113, without consensus-based processing, and may broadcast the updated version of the distributed ledger across communications network 140 to the other components of the distributed ledger network.

In some examples, the distributed ledger, such as distributed ledger 113, may be a locally maintained version of the distributed ledger stored in a memory of a client device (e.g., memory 111 of client device 110). Additionally, each of one or more elements of the distributed ledger may be a smart contract element and each smart contract element may record code or software instructions that characterize one or more conditions for a particular transaction related to a particular digital asset. Upon satisfaction of the one or more conditions, a network of computing devices or systems may execute the code or software instructions that cause the network of computing devices or systems to automatically perform operations that transfer a digital asset from one user to another user, such as the user of client device 110. Additionally, upon transfer of the digital asset to the other user (e.g., user of client device 110), a client device, such as client device 110, may perform any of the exemplary processes as described herein to record or mint an object within one or more elements of the distributed ledger, such as a digital token, that indicate the current ownership of the digital asset.

In some instances, the digital token may be a non-fungible token (NFT). Additionally, the digital token may include data identifying and characterizing a name of the digital token, a token symbol, and a unique identifier (e.g., an ERC-721 identifier) associated with the digital token. In other instances, each smart contract element may include data identifying and characterizing a unique identifier associated with the corresponding smart contract, unique properties of the corresponding digital asset, information stored in a corresponding digital token (e.g., the name of the digital token, the token symbol, and the unique identifier associated with the digital token), and information (e.g., an address) of one or more DSP computing systems, such as DSP computing system 120, that may provide the corresponding digital asset to one or more third party devices 130, such as third party device 131, third party device 132, third party device 133. In some examples, the digital asset may be included in the digital token. In other examples, the digital asset may be stored on a separate database, such as another computing system. Examples of digital assets include at least one of, audio content (e.g., music (songs, albums, etc.), podcasts, audio books, audio ads, etc.), video content (e.g., movies, television shows, etc.), gaming content (e.g., graphic datasets for characters of a particular video game or recordings of gameplay of a particular video game), documents (e.g., deeds to property, tickets to real world events, tokenized invoices, legal documents, signatures), etc.

In other examples, the one or more client devices, such as client device 110, may perform operations that generate metadata associated with an object, such as a digital token, indicating a current ownership of a digital asset, included in one or more elements of a distributed ledger, such as distributed ledger 113. In some instances, the metadata may include data identifying and characterizing the current owner and previous owner of a digital asset identified in an object, such as a digital token, a name of the digital token, a unique identifier associated with the corresponding digital asset, and identifying and characterizing unique properties of a corresponding digital asset. By way of example, a digital asset may be identified in an object of distributed ledger 113, such as a digital token, that identifies an ownership of the digital asset. Additionally, the digital asset may include music content (e.g., the content of a particular song, the content of a particular collection of songs (e.g., the content of an album), etc.). Further, the metadata may identify and characterize unique properties of the music content or file, such as the waveform and tempo of the music content or file. In some examples, the metadata may be recorded in one or more elements of the distributed ledger, such as distributed ledger 113. Additionally, or alternatively, the metadata may be stored in a separate database (not illustrated in FIG. 1).

Referring back to FIG. 1, the one or more client devices, such as client device 110, may store within the one or more tangible non-transitory memories, an executable intermediary application, such as intermediary application 114. The intermediary application may be provisioned to the one or more client devices and supported by intermediary computing system 101. In some instances, and upon execution by the one or more processors of a client device, such as client device 110, the intermediary application may establish communications with intermediary computing system 101, and may perform any of the exemplary processes described herein to, among other things, access the locally maintained version of a distributed ledger stored in memory 111, such as distributed ledger 113, obtain information or data, such as, an identifier of an object (e.g., a digital token) indicating an ownership of a particular digital asset. By way of example, executed intermediary application 114 may access the locally maintained version of distributed ledger 113 stored in memory 111 to obtain an ERC-721 identifier of an ERC-721 token included in the locally maintained version of distributed ledger 113.

Additionally, the intermediary application may establish communications with intermediary computing system 101, and may perform any of the exemplary processes described herein to, among other things, communicate the obtained information or data of an object of the distributed ledger (e.g., an identifier of the object) to intermediary computing system 101. By way of example, processor 115 of client device 110 may execute intermediary application 114. Additionally, executed intermediary application 114 may generate a digital interface with one or more input fields for the user into input information that enables the intermediary application 114 to gain access to distributed ledger 113 of the user operating client device 110. Examples of information the user may input into the one or more input fields includes, a network identifier, a node address, such as a remote procedure call (RPC) uniform resource locator (URL), a distributed ledger identifier, a type of token associated with the distributed ledger (e.g, Etherium™ or ETC, Bitcoin™ or BTC, etc.), and/or an explorer address (e.g., a URL of a website that enables a user to track, monitor, evaluate and/or manage the distributed ledger). Moreover, executed intermediary application 114 may transmit a request to gain access to distributed ledger 113 utilizing the received information. In examples where the distributed ledger 113 authorizes executed intermediary application 114 to access distributed ledger 113 of the user operating client device 110, executed intermediary application 114 may obtain, from distributed ledger 113, an identifier of a digital token, such as a non-fungible token (e.g., ERC-721 token), of a particular digital asset. Further, executed intermediary application 114 may transmit the identifier of the digital token to intermediary computing system 101. As described herein, intermediary computing system 101 may utilize the identifier of the digital token to track and monitor the usage of the corresponding digital asset by one or more other or third party users. As described herein, the usage of the corresponding digital asset may include interactions of the corresponding digital asset by one or more additional devices, such as third party devices 130, associated with the one or more other or third party users.

In some examples, the executed intermediary application (e.g., intermediary application 114) may access versions of one or more distributed ledgers locally maintained on a client device, such as client device 110, through another application, such as a wallet application (e.g., wallet application 112). In such examples, the wallet application may already have access or linked to the one or more distributed ledgers of a user of a client device, such as a user of client device 110. Additionally, the executed intermediary application may perform operations, as described herein, to communicate with the wallet application, such as wallet application 112, to access the one or more distributed ledgers of the user of the client device. For example, processor 115 of client device 110 may execute intermediary application 114 and wallet application 112. Additionally, executed intermediary application 114 may generate a digital interface with one or more input fields for the user to input information that enables executed intermediary application 114 to communicate and access/link executed wallet application 112 and access distributed ledger 113 through executed wallet application 112. Examples of information the user may input includes login information associated with the user and wallet application 112, such as a username or e-mail associated with wallet application 112 and corresponding password. Moreover, executed intermediary application 114 may communicate the inputted information along with a request to link or access distributed ledger 113 to executed wallet application 112. Executed wallet application 112 may utilize the inputted information along with the request to determine or verify the inputted information is correct (e.g., the username or e-mail and password combination are correct). In response to executed wallet application 112 determining or verifying the inputted information is correct, executed wallet application 112 may allow executed intermediary application 114 to link to executed wallet application 112 and access distributed ledger 113. Executed intermediary application 114 may access and obtain, from distributed ledger 113 via wallet application 112, an identifier of a digital token, such as an identifier of a non-fungible token, of a digital asset. Further, executed intermediary application 114 may transmit the identifier of the digital token to intermediary computing system 101. As described herein, intermediary computing system 101 may utilize the identifier of the digital token to track and monitor the usage of the corresponding digital asset by one or more other or third party users.

In some instances, the executed intermediary application, such as intermediary application 114, may transmit device data of the corresponding client device, such as client device 110, along with the identifier of the digital token to intermediary computing system 101. The device data may uniquely identify the corresponding client device. Further, intermediary computing system 101 may utilize the identifier of the digital token and/or the device data to determine to which client device to transmit information identifying or characterizing the usage of the corresponding digital asset.

In other instances, while the executed intermediary application (e.g., intermediary application 114) and executed wallet application (e.g., wallet application 112) are linked, the executed intermediary application may identify all digital tokens, such as non-fungible tokens, that identify or indicate an ownership of a particular digital asset. In such instances, the user operating the client device, such as client device 110, may indicate or select one or more of the identified digital tokens for the intermediary application to initiate operations to track and monitor the usage of the corresponding digital asset by one or more other or third party users.

By way of example, while executed intermediary application 114 and executed wallet application 112 are linked, executed intermediary application 114 may access and identify, from distributed ledger 113 via wallet application 112, an identifier of each digital token, such as a non-fungible token, that indicates an ownership of a particular digital asset. Additionally, based on the identified digital tokens, intermediary application 114 may generate a digital interface with interface elements that graphically represent each of the identified digital tokens. Moreover, each of the interface elements may be configured to be selectable. Executed intermediary application 114 may initiate processes and operations to track and monitor the usage of the corresponding digital assets of each interface element that is selected. In some instances, the processes and operations may include communicating with one or more computing systems within computing environment 100, such as intermediary computing system 101, and one or more DSP computing systems, such as DSP computing system 120 to track and monitor the usage of the corresponding digital assets. Such operations may include, intermediary application 114 generating and transmitting, to intermediary computing system 101, a request to track and monitor one or more digital assets of corresponding interface elements that were selected along with the information or data (e.g., an identifier) of corresponding digital token(s). In some instances, intermediary application 114 may further transmit, to intermediary computing system 101, additional data/information such as, information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of the corresponding client device, along with the request.

In various instances, intermediary application 114 may identify all digital tokens, such as non-fungible tokens, that identify or indicate an ownership of a particular digital asset and are associated with a DSP computing system, such as DSP computing system 120. For example, while executed intermediary application 114 and executed wallet application are linked, executed intermediary application 114 may access and identify, from distributed ledger 113 via wallet application 112, an identifier of each digital token, such as a non-fungible token, of a particular digital asset. Additionally, executed intermediary application 114 may access and identify, from distributed ledger 113 via executed wallet application 112, an element, such as a smart contract element, associated with each identified digital token. Moreover, executed intermediary application 114 may parse each identified smart contract element of each identified digital token to determine which identified smart contract element includes information (e.g., an address) regarding a DSP computing system, such as DSP computing system 120, that may provide a corresponding digital asset to one or more third party users. Further, executed intermediary application 114 may generate an interface element of each digital token that has an associated smart contract element determined or identified as including information identifying DSP computing system that may be providing a corresponding digital asset to one or more third party users. Each interface element may be configured to be selectable. Executed intermediary application 114 may initiate processes and operations to track and monitor the usage of the corresponding digital assets of each interface element that is selected. In some instances, the processes and operations may include communicating with one or more computing systems within computing environment 100, such as intermediary computing system 101, and one or more DSP computing systems, such as DSP computing system 120 to track and monitor the usage of the corresponding digital assets. Such operations may include, intermediary application 114 generating and transmitting, to intermediary computing system 101, a request to track and monitor one or more digital assets of corresponding interface elements that were selected along with the information or data (e.g., an identifier) of corresponding digital token(s). In some instances, intermediary application 114 may further transmit, to intermediary computing system 101, additional data/information such as, information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of the corresponding client device, along with the request.

Referring back to FIG. 1, as described herein, the intermediary application, such as intermediary application 114, may communicate with intermediary computing system 101 to obtain metric data associated with a usage of the digital asset. As described herein, the metric data my include one or more metrics associated with the usage of the digital asset by one or more third party users. Additionally, the executed intermediary application may communicate with executed wallet application to transmit the metric data to executed wallet application. In some instances, executed wallet application 112 may cause client device 110 to perform operations that record one or more portions of the metric data within at least one element of distributed ledger 113. In other instances, executed wallet application 112 may perform operations that cause client device 110 to record portions of the metric data that are mutable relative to the digital asset.

By way of example, the digital asset may be music content (e.g., particular song content, particular collection of song content (e.g., particular album)). Additionally, the metric data may include immutable type data, such as the wave form and tempo of the music content, and mutable type data, such as data characterizing a number of indications the digital asset was liked, a number of times the digital asset was interacted with, and/or a number of times the digital asset was added to a list associated with an account of at least one of the one or more additional devices. Moreover, executed wallet application 112 may identify which of the portions of metric data include immutable type data and mutable type data, and cause the client device 110 to record portions of metric data that are mutable within at least one element of the distributed ledger 113.

In some instances, the elements of the distributed ledger 113 that include portions of metric data that are mutable type data may also include immutable type data such as information or data identifying the corresponding digital token and/or digital asset. For instance, the elements of the distributed ledger 113 that include portions of metric data of a particular digital asset may include data identifying and characterizing a name of the digital token, a token symbol, and/or a unique identifier associated with the digital token. Additionally, or alternatively, the elements of the distributed ledger 113 that includes portions of metric data of a particular digital asset may include data identifying and characterizing a unique identifier associated with the corresponding smart contract, and/or unique properties of the corresponding digital asset.

In other instances, the executed intermediary application, such as intermediary application 114, may perform operations, described herein, to generate and render for presentation at a computing device of a user, such as client device 110, a digital interface, such as an interactive digital dashboard, having one or more tracker interface elements that identify, for each digital token of the user, one or more metrics of a corresponding digital asset. For example, executed intermediary application 114 may communicate with executed wallet application 112 to identify, for each of the one or more digital tokens included in distributed ledger 113, one or more elements of distributed ledger 113 that includes one or more portions of metric data obtained from DSP computing systems, such as DSP computing system 120. In such an example, executed intermediary application 114 may parse through each element of distributed ledger 113 to determine, for each of the one or more digital tokens, which of the elements that includes the one or more portions of metric data and is associated with the corresponding digital token based on information or data identifying a digital token and/or corresponding digital asset. Additionally, executed intermediary application 114 may obtain, for each of the one or more digital tokens, metric data associated with each of the one or more digital tokens. Further, executed intermediary application 114 may generate, for each of the one or more digital tokens, one or more tracker interface elements of the digital interface (e.g., an interactive digital dashboard) based on the one or more portions of metric data of each of the one or more digital tokens. The tracker interface elements of each of the one or more digital tokens may be a graphical representation of the one or more metrics characterized and identified in the associated metric data.

In some instances, the tracker interface elements may provide a graphical representation of the most current metrics of a digital asset of a particular digital token. In other instances, the tracker interface elements may provide a graphical representation of historical data characterizing trends of each of the metrics of the corresponding digital asset of a particular digital token during a current temporal interval and over one or more prior temporal intervals (e.g., hour, day, week, month, etc.). In various instances, the digital interface may include, for one or more metrics of the corresponding digital asset of each of the one or more digital tokens, a graphical representation of an aggregate value of the associated metric during the current temporal interval and across and one or more prior temporal intervals.

Each client device, such as client device 110, may include a display unit, such as display unit 116A, configured to present interface elements to a corresponding user, such as a user of client device 110, and an input unit, such as input unit 116B, configured to receive input from the user (e.g., in response to the interface elements presented through the display unit). By way of example, the display unit may include, but is not limited to, an LCD display unit, a TFT display, and OLED display or other appropriate type of display unit, and input unit may include, but is not limited to, a keypad, keyboard, touchscreen, fingerprint scanner, voice activated control technologies, or appropriate type of input unit. Further, in additional aspects (not illustrated in FIG. 1), the functionalities of the display unit and input unit may be combined into a single device, e.g., a pressure-sensitive touchscreen display unit that presents interface elements and receives input from a user, such as user of client device 110. In various instances, client device 110 may include an embedded computing device (e.g., in communication with a smart textile or electronic fabric), and any other type of computing device that may be configured to store data and software instructions, execute software instructions to perform operations, and/or display information on an interface device or unit, such as display unit 116A.

Moreover, each client device, such as client device 110, may include a communications interface, such as communications interface 116C, such as a wireless transceiver device, coupled to a processor of client device 110, such as processor 115, and configured by the processor to establish and maintain communications with communications network 140 via one or more communication protocols, such as WiFi®, Bluetooth®, NFC, a cellular communications protocol (e.g., LTE®, CDMA®, GSM®, etc.), or any other suitable communications protocol. In some instances, each of client devices 110 may also establish communications with one or more additional computing systems or devices operating within computing environment 100 across a wired or wireless communications channel, such as communications network 140 (e.g., via the communications interface 116D using any appropriate communications protocol).

In some instances, each client device, such as client device 110, may be associated with or operable by a user. Examples of client devices may include, but are not limited to, a personal computer, a laptop computer, a tablet computer, a notebook computer, a hand-held computer, a personal digital assistant, a portable navigation device, a mobile phone a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform one or more of the exemplary processes described herein.

Referring back to FIG. 1, intermediary computing system 101 may represent a computing system that includes one or more servers, such as server 120A, and one or more tangible, non-transitory memory devices storing executable code, application engines, or application modules. Each of the one or more servers may include one or more processors, which may be configured to execute portions of the stored code, application engines or modules, or application programs to perform operations consistent with the disclosed exemplary embodiments. For example, as illustrated in FIG. 1, the one or more servers of intermediary computing system 101 may include server 101A having one or more processors configured to execute portions of the stored code, application engines or modules, or application programs maintained within the one or more tangible, non-transitory memories.

In some instances, intermediary computing system 101 may correspond to a discrete computing system, although in other instances, intermediary computing system 101 may correspond to a distributed computing system having multiple, computing components distributed across an appropriate computing network, such as communications network 140 of FIG. 1, or those established and maintained by one or more cloud-based providers, such as Microsoft Azure™, Amazon Web Services™, or another third-party, cloud-services provider. Further, intermediary computing system 101 may also include one or more communications interfaces, such as one or more wireless transceivers, coupled to the one or more processors for accommodating wired or wireless internet communication across communications network 140 with other computing systems and devices operating within computing environment 100 (not illustrated in FIG. 1).

In some examples, intermediary computing system 101 may perform any of the exemplary processes described herein to, among other things, to coordinate the tracking and monitoring of digital assets of a distributed ledger, such as distributed ledger 113. Additionally, intermediary computing system 101 may support the intermediary application, such as intermediary application 114, and perform operations to obtain, from an intermediary application executing on a client device, such as executed intermediary application 114 of client device 110, information or data (e.g., an identifier) of a digital token, such as a non-fungible token, from a distributed ledger of a particular user, such as distributed ledger 113 of a user that is operating client device 110 executing intermediary application 114. The information or data (e.g., an identifier) of the digital token may be utilized by intermediary computing system 101 to coordinate the tracking and monitoring of associated digital assets of the distributed ledger. In some instances, intermediary computing system 101 may obtain, from the intermediary application, device data of the corresponding client device, such as client device 110, along with the information or data (e.g., an identifier) of the digital token. As described herein, the device data may uniquely identify the client device. Additionally, intermediary computing system 101 may utilize the identifier of the digital token and/or the device data to determine to which client device to transmit information identifying or characterizing the usage of the corresponding digital asset.

To facilitate the performance of these exemplary processes, intermediary computing system 101 may maintain within the one or more tangible, non-transitory memories, such as data repository 102 that includes, but is not limited to account database 103 and metric database 104. Account database 103 may store account data. Account data may include information or data (e.g., an identifier) of a digital token, such as a non-fungible token, obtained from one or more client devices, such as client device 110. In some instances, account data may include a DSP computing system compatible identifier of the digital token generated by intermediary computing system 101 and based on the information or data of the digital token. In other instances, account data may include information or an address of one or more DSP computing systems, such as DSP computing system 120, that may provide the corresponding digital asset to one or more third party devices 130, such as third party device 131, third party device 132, third party device 133. In various instances, account data may include information identifying and characterizing the digital asset, such as one or more unique properties of the digital asset (e.g., wave form, tempo, file name, etc.). In some instances, account data may include the device data of each client device that transmitted the information or data of an associated digital token. Additionally, metric database 104 may include metric data obtained from one or more DSP computing systems, such as DSP computing system 120. In some instances, the metric data may identify and characterize one or more metrics related to the usage of a digital asset. In some instances, metric data may include data identifying or linking portions of the metric data to a particular DSP computing system compatible identifier and/or information or data of a digital token in the account data stored in account database 103.

Further, and to facilitate the performance of any of the exemplary processes described herein, intermediary computing system 101 may include server 101A that may maintain within the one or more tangible non-transitory memories, an application repository 105. Application repository 105 may include, among other things, conversion engine 105A and update engine 105B. In some examples, conversion engine 105A may be executed by one or more processors of server 101A to generate and transmit a DSP computing system compatible identifier based on information or data (e.g., an identifier) of a digital token of a distributed ledger, such as distributed ledger 113, obtained from an intermediary application executing on a client device, such as executed intermediary application 114 of client device 110. In such examples, executed conversion engine 105A may obtain, from an intermediary application executing on a client device, such as executed intermediary application 114 of client device 110, the information or data (e.g., an identifier) of the digital token. Additionally, executed conversion engine 105A may generate a DSP computing system compatible identifier based on the obtained information or data of the digital token. In some instances, executed conversion engine 105A may store the obtained information or data of the digital token and the DSP computing system compatible identifier into corresponding portions of data repository 102, such as account database 103.

In some instances, executed conversion engine 105A may further obtain, from the intermediary application executing on the client device, additional information/data associated with the obtained information or data (e.g., an identifier) of the digital token, such as information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of the corresponding client device. Additionally, executed conversion engine 105A may store the additional information/data. into corresponding portions of data repository 102, such as account database 103.

Additionally, executed conversion engine 105A may provide or transmit the generated DSP computing system compatible identifier along with a request for metric data or to track and monitor a digital asset associated with the DSP computing system compatible identifier to one or more DSP computing systems, such as DSP computing system 120. In some examples, executed conversion engine 105A may parse the account data to identify portions of account data associated with the generated DSP computing system compatible identifier. Additionally, executed conversion engine 105A may obtain portions of the account data associated with the generated DSP computing system compatible identifier that include information or an address of one or more DSP computing systems, such as DSP computing system 120, that may provide the corresponding digital asset to one or more third party devices 130. Moreover, based on the obtained information or address of the one or more DSP computing systems, executed conversion engine 105A may transmit the DSP computing system compatible identifier to the one or more DSP computing systems. In some instances, executed conversion engine 105A may transmit information identifying and characterizing a digital asset (e.g., unique properties of the digital asset) associated with the digital token and the DSP computing system compatible identifier. For instance, executed conversion engine 105A may obtain, from account database 103, information identifying and characterizing a digital asset (e.g., unique properties of the digital asset) associated with the digital token and the DSP computing system compatible identifier. In such instances, executed conversion engine 105A may transmit to the one or more DSP computing systems, such as DSP computing system 120, the request along with the DSP computing system compatible identifier and the information identifying and characterizing the associated digital asset (e.g., unique properties of the digital asset).

Referring back to FIG. 1, update engine 105B may be executed by one or more processors of server 101A to obtain from the one or more DSP computing systems, such as DSP computing system 120, a message including the DSP computing system compatible identifier along with metric data identifying and characterizing one or more metrics associated with the usage of the digital asset associated with the DSP computing system compatible identifier. In some instances, executed update engine 105B may store the metric data into corresponding portions of data repository 102, such as metric database 104. In such instances, executed update engine 105B may identify, based on the DSP computing system compatible identifier included in the message, portions of account data stored in account database 103 associated with the metric data included in the message. Additionally, executed update engine 105B may process the metric data to include data identifying or linking portions of the metric data to the identified portions of the account data (e.g., a particular DSP computing system compatible identifier and/or information or data of a digital token) stored in account database 103. As described herein, the metric data may include mutable and immutable type data.

Moreover, executed update engine 105B may transmit the metric data to the executed intermediary application of the client device, such as executed intermediary application 114 of client device 110. For example, executed update engine 105B may parse the account data stored in account database 103 to identify portions of account data, such as a corresponding DSP computing system compatible identifier, corresponding information or data (e.g., an identifier) of a digital token, and/or device data associated with the DSP computing system compatible identifier and/or metric data included in the message. Additionally, executed update engine 105B may determine to which client device to transmit the metric data, based on the identified portions of account data, and transmit the metric data that was included in the message to the determined client device (e.g., client device 110).

As described herein, a DSP computing system, such as DSP computing system 120, may be associated with a digital content provider, and may be operated by one or more operators of the digital content provider (e.g., Spotify™). Additionally, the DSP computing system may represent a computing system that includes one or more servers, such as server 120A, and one or more tangible, non-transitory memory devices storing executable code, application engines, or application modules. Each of the one or more servers may include one or more processors, which may be configured to execute portions of the stored code, application engines or modules, or application programs to perform operations consistent with the disclosed exemplary embodiments. For example, as illustrated in FIG. 1, the one or more servers of DSP computing system 120 may include server 120A having one or more processors configured to execute portions of the stored code, application engines or modules, or application programs maintained within the one or more tangible, non-transitory memories.

Further, as described herein, the one or more DSP computing systems may each provide content of digital assets of one or more users, such as a user of client device 110, to one or more other or third party users (e.g. users of third party devices 130). Examples of content of digital assets includes music content, video content, imaging content, gaming content, and document content. In some examples, the digital asset may already be provided to the one or more third party users when the ownership of the digital asset is transferred to a user, such as a user of client device 110. In such examples, an object (e.g., a digital token) stored or recorded in at least an element of a distributed ledger of a user, such as distributed ledger 113, may indicate a transfer of the ownership of the digital asset to the user or that the user is the current owner of the digital asset.

In other examples, not illustrated in FIG. 1, the digital asset may be new and not yet accessible to the DSP computing systems and may be stored on a separate database, such as a distributed peer to peer network that stores the digital asset across multiple nodes, devices or computing systems (e.g., Interplanetary File System (IPFS)). In such examples, a smart contract element associated with a corresponding digital token of the digital asset may identify which of the one or more DSP computing systems, such as DSP computing system 120 may access and obtain the digital asset from the separate database. Additionally, the smart contract element may indicate how and the parameters in which the identified one or more DSP computing systems may access and obtain the digital asset from the separate database. For example, the smart contract element may indicate that intermediary computing system 101 may obtain, from the separate database, and transmit, to one or more DSP computing systems, such as DSP computing system 120, a copy of the digital asset. By way of example, a first digital token may indicate ownership of a digital asset that includes music content and is stored in a separate database (not illustrated in FIG. 1). Additionally, a corresponding smart contract element, identifying DSP computing system 102 as being granted access to the digital asset and indicating that DSP computing system 102 may obtain a copy of the digital asset. Based on the smart contract element and while executed intermediary application 114 and executed wallet application 112 are linked, executed intermediary application 114 may access distributed ledger 113 to access a first digital token, such as a non-fungible token, to obtain information or data included in the first digital token, such as an identifier of the first digital token. Additionally, executed intermediary application 114 may determine where the digital asset of the first digital token is located—either based on the metadata associated with the first digital token or a smart contract element associated with the first digital token. For instance, executed intermediary application 114 may identify a smart contract element associated with the first digital token on distributed ledger 113, parse the smart contract element and determine and obtain location information indicating where the associated digital asset is stored. Alternatively, executed intermediary application 114 may identify or obtain metadata associated with the first digital token on distributed ledger 113, parse the metadata and determine and obtain location information indicating where the associated digital asset is stored. Based on the location information and the information or data included in the first digital token, executed intermediary application 114 may transmit, to intermediary computing system 101, the information or data included in the first digital token (e.g., an identifier of the first token) along with the location information. Intermediary computing system 101 may obtain or retrieve a copy of the digital asset from where the location information indicated the digital asset is stored (e.g., a separate database) and transmit the copy of the digital asset to one or more DSP computing systems. The one or more DSP computing systems may provide the music content of the digital asset to one or more third party users of the DSP computing systems.

Referring back to FIG. 1, the one or more DSP computing systems, such as DSP computing system 120, may perform operations as described herein to track and monitor the usage of content of a particular digital asset owned by a user (e.g., user of client device 110) on the DSP computing system. Moreover, the one or more DSP computing systems may perform operations to generate and transmit, to intermediary computing system 101, metric data identifying and characterizing one or more metrics related to the usage of the content of the digital asset by one or more third party users of the DSP computing system. As described herein, the usage of the corresponding digital asset may include interactions of the content of the digital asset by one or more additional devices, such as third party devices 130, associated with the one or more third party users of the DSP computing system.

To facilitate the performance of tracking and monitoring the usage of content of a particular digital asset of a user and generating metric data identifying and characterizing one or more metrics identifying and characterizing the usage of the content of the digital asset, each of the one or more DSP computing systems, such as DSP computing system 120, may maintain within the one or more tangible, non-transitory memories, such as data repository 121 that includes, but is not limited to account database 122. Account database 122 may store account data 122A. Account data 122A may identify and characterize one or more account profiles of users, such as a user of client device 110. Each of the one or more account profiles of users may have content of digital assets that a corresponding DSP computing system, such as DSP computing system 120, may provide to one or more other or third party users. In some instances, each account profile included in account data 122A may include metric data. As described herein, metric data may identify and characterize one or more metrics related to the usage of corresponding content of a digital asset by one or more third party users of a DSP computing system. In other instances, one or more of the account profiles may further include a DSP computing system compatible identifier and/or information identifying and characterizing an associated digital asset obtained from intermediary computing system 101.

Further, and to facilitate the performance of any of the exemplary processes described herein, each of the one or more DSP computing systems, such as DSP computing system 120 may include one or more servers, such as server 120A, that may maintain within the one or more tangible non-transitory memories, an application repository 125. Application repository 125 may include, among other things, account engine 125A, monitoring engine 125B, analysis engine 125C, and notification engine 125D. Account engine 125A may be executed by one or more processors of server 120A to obtain, from intermediary computing system 101, such as executed conversion engine 105A, a DSP computing system compatible identifier along with a request for metric data (or to track and monitor a digital asset associated with the DSP computing system compatible identifier). In some instances, executed account engine 125A may further obtain, from intermediary computing system (e.g., executed conversion engine 105A), information identifying and characterizing an associated digital asset. Additionally, executed account engine 125A may generate an account profile in account data 122A based on and in response to receiving the DSP computing system compatible identifier. In some instances, executed account engine 125A may store, the obtained DSP computing system compatible identifier and/or information identifying and characterizing an associated digital asset within the corresponding generated account profile stored in account database 122.

Monitoring engine 125B may be executed by one or more processors of server 120A to obtain the DSP computing system compatible identifier and/or information identifying and characterizing an associated digital asset of one or more account profiles stored in account database 122. Additionally, executed monitoring engine 125B may perform operations to track and monitor the usage of digital assets by third party users. In some instances, executed monitoring engine 125B may utilize the DSP computing system compatible identifier and/or information identifying and characterizing an associated digital asset of each of the one or more account profiles to track and monitor the usage of the digital assets by third party users.

By way of example, a digital asset of a user operating client device 110 may include music content that DSP computing system 120 provides to one or more third party users. Additionally, account data 122A stored in account database 122 may include an account profile of the user comprising a DSP computing system compatible identifier associated with the digital token (e.g., a non-fungible token) of the digital asset and/or information identifying and characterizing the digital asset. Moreover, executed monitoring engine 125B may be configured to track and monitor the usage of the music content by one or more third party users. In some instances, DSP computing system 120 (or any other DSP computing system) may support and maintain a DSP application program that may be executed by one or more processors of each of the one or more third party devices 130. Additionally, the executed DSP application program may be configured to provide (e.g., stream), the music content through the one or more third party devices 130, and third party users operating the one or more third party devices 130 may interact with the music content using the executed DSP application program. Examples of interactions the executed DSP application program may enable a corresponding third party user to do include, for example, playing or streaming the music content, indicating whether the third music content is liked, indicating the number of times the music content was played or skipped, and a number of times the music content was added to a list, such as a play list, by the corresponding third party user. Moreover, the executed DSP application program may be configured to monitor and track the various interactions between a corresponding third party user and the music content, and generate interaction data. The interaction data may identify and characterize the interactions, a timestamp of the occurrence of each interaction, and information identifying and characterizing the digital asset of the music content (e.g., wave form, tempo, file name, etc.). Further, the executed DSP application program may transmit to DSP computing system 120 the interaction data of the music content of the digital asset. Executed monitoring engine 125B may parse the interaction data to obtain data characterizing and identifying the interactions, a time stamp of the occurrence of each interaction and information identifying and characterizing the digital asset of the music content. Based on the information identifying and characterizing the digital asset of the music content in the interaction data and the information identifying and characterizing a digital asset included in account profiles stored in account data 122A, executed monitoring engine 125B may identify an account profile in account data 122A where the information identifying and characterizing a digital asset included in the account profile matches with the information identifying and characterizing the digital asset of the music content in the interaction data. Additionally, executed monitoring engine 125B may store portions of the interaction data that characterize and identify the interactions, a time stamp of the occurrence of each interaction within a corresponding account profile in account data 122A.

Referring back to FIG. 1, analysis engine 125C may be executed by the one or more processors of server 120A to generate, for each account profile in account data 122A, metric data based on interaction data included in each account profile. As described herein, the metric data may include one or more metrics associated with the usage of content of a digital asset by one or more third parties (e.g., users of a DSP computing system) or interactions of the content of the digital asset by one or more third party devices 130 of the one or more third parties (e.g. users of. a DSP application program supported or maintained by a DSP computing system). By way of example, executed analysis engine 125C may obtain, for a particular account profile of a user operating client device 110, interaction data. Additionally, based on the interaction data, executed analysis engine 125C may generate the metric data.

In some instances, executed analysis engine 125C may generate metric data that includes one or more metrics that aggregate the interactions during a particular time interval. In such instances, a request for metric data or for tracking and monitoring a particular digital asset transmitted by intermediary computing system 101 and received by a DSP computing system, may include a timing parameter. The timing parameter may indicate the time interval (e.g., previous sixty days from the date of receipt of the request). For instance, intermediary computing system 101 may be configured to transmit a request for metric data (or for tracking and monitoring a particular digital asset), to DSP computing system 120, periodically—every other month. The timing parameter of the request may indicate a time interval for the requested metric data. In response to and based on the request, the corresponding DSP computing system, such as DSP computing system 120, transmits the metric data to intermediary computing system 101 that includes one or more metrics that identify and characterize the aggregate interactions during the time interval identified in the timing parameter of the request (e.g., the past sixty days). Examples of the one or metrics include a number of times the content of the digital asset was liked in the thirty-day time interval; a number of times the content of the digital asset was interacted within the thirty-day time interval (e.g., number of times a music content of the digital asset was played or skipped during the thirty-day time interval), and/or a number of times the content of the digital asset was added to a list (e.g., a play list) within the thirty-day time interval. In some instances, executed analysis engine 125C may store the generated metric data in a corresponding account profile in account data 122A that stored the interaction data of which the metric data was based off.

Further, notification engine 125D may be executed by one or more processors of server 120A to generate and transmit a message that includes one or more portions of metric data to intermediary computing system 101. In some examples, executed notification engine 125D may, for each of one or more account profiles, generate a message and package into portions of the message one or more portions of metric data of the corresponding account profile. Additionally, executed notification engine 125D may transmit the message of each of the one or more account profiles to intermediary computing system 101.

### B. Computer-Implemented Techniques for Tracking and Monitoring Usage of Digital Assets of Distributed Ledgers

As described herein, intermediary computing system 101 may coordinate communications between a distributed ledger of a user, such as distributed ledger 113, and one or more DSP computing systems, such as DSP computing system 120 configured to provide one or more digital assets of the distributed ledger to one or more third party users. For example, intermediary computing system 101 may perform operations, as described herein, to obtain metric data identifying and characterizing one or more metrics of the usage of the one or more digital assets by the one or more other or third party users. Additionally, intermediary computing system 101 may coordinate the recording of one or more portions of the metric data onto a corresponding distributed ledger of the user. In some instances, the intermediary computing system 101 may be configured to cause the computing device of the user, such as client device 110, to present a graphical representation of at least one of the one or more metrics within a digital interface, such as an interactive digital dashboard.

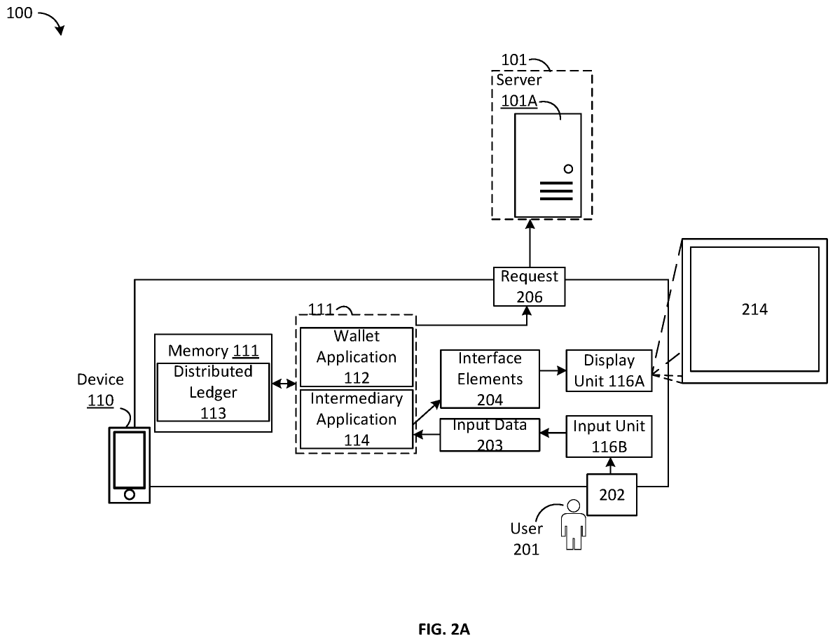

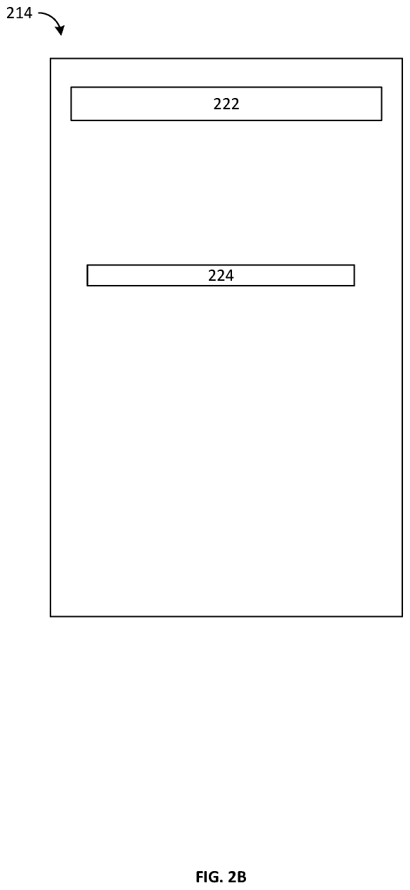

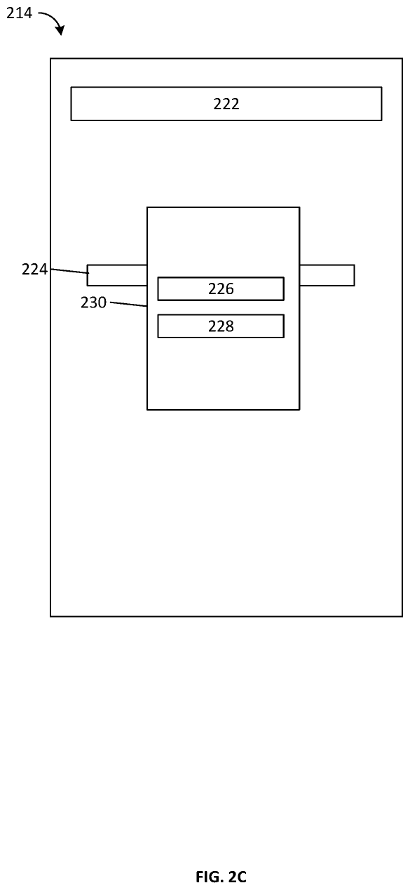

In some examples, as illustrated in FIG. 2A, executed intermediary application 114 may perform operations that generate and route interface elements 204 to display unit 116A. Additionally, when rendered for presentation within a digital interface 214 by display unit 116A, interface elements 204 may prompt user 201 of client device 110 to provide input 202 to input unit 116B. Input 202 may include information that enables intermediary application 114 to access a locally maintained version of distributed ledger 113. Additionally, input unit 116B may generate input data 203 based on input 202. Input data 203 may identify and characterize the information of input 202 that user 201 provided. In some instances, the interface elements 204 may include one or more input fields for user 201 to provide input 202 into.

In some examples, based on input data 203, executed intermediary application 114 may access the locally maintained version of distributed ledger 113. In such examples, the information of input 202 may include a network identifier, a node address, such as a remote procedure call (RPC) uniform resource locator (URL), a distributed ledger identifier, type of token associated with the distributed ledger (e.g, Etherium™ or ETC, Bitcoin™ or BTC, etc.), explorer address (e.g., a URL of a website that enables a user to track, monitor, evaluate and/or manage the distributed ledger. Additionally, based on input data 203, intermediary application 114 may access and obtain, from distributed ledger 113, an identifier of a digital token, such as a non-fungible token (e.g., ERC-721 token), of a particular digital asset. Further, executed intermediary application 114 may generate request 206 that includes the identifier of the digital token and transmit request 206 to server 101A of intermediary computing system 101. In some instances, executed intermediary application 114 may include device data of client device 110 into request 206 along with the identifier of the digital token. As described herein, the device data may uniquely identify client device 110.

In other examples, based on input data 203, intermediary application 114 may communicate with executed wallet application 112 to access the locally maintained version of distributed ledger 113. In such examples, the information of input 202 may include login information associated with the user and wallet application 112, such as a username or e-mail associated with wallet application 112 and corresponding password. Additionally, intermediary application 114 may communicate input data 203 including login information associated with the user and wallet application 112, along with a request to link or access distributed ledger 113 to executed wallet application 112. Executed wallet application 112 may utilize the information of input data 203 along with the request to determine or verify the the information of input data 203 is correct (e.g., the username or e-mail and password combination are correct). Upon executed wallet application 112 determining or verifying the information of input data 203 is correct, executed wallet application 112 may allow executed intermediary application 114 to link with executed wallet application 112 and access distributed ledger 113. Additionally, executed intermediary application 114 may access and obtain, from distributed ledger 113 via wallet application 112, an identifier of a digital token, such as a non-fungible token, of a digital asset. Further, executed intermediary application 114 may generate request 206 that includes the identifier of the digital token and transmit request 206 to server 101A of intermediary computing system 101. In some instances, executed intermediary application 114 may include device data of client device 110 into request 206 along with the identifier of the digital token. As described herein, the device data may uniquely identify client device 110.

FIG. 2B and FIG. 2C, illustrate examples of a digital interface 214. In some examples, as illustrated in FIG. 2B, the digital interface 214 may include a header 220 along with a selectable interface element 222. The selectable interface element 222 may be a button that prompts a user, such as user 201, to interact with it or push it, via input unit 116B, to trigger the presentation of another panel that includes the one or more input fields into which a user 201 is to provide input. FIG. 2C illustrates the digital interface 214 after the user interacts with the selectable interface element 222. In some examples, as illustrated in FIG. 2C, panel 230 may be generated and presented. Additionally, panel 230 may overlay the selectable interface element 222 and include the one or more input fields, input field 226 and input field 228, into which a user 201 is to provide input. In some instances, input field 226 may prompt a user to input a user name into input field 226, via input unit 116B. In other instances, input field 228 may prompt a user to input a password associated with the user name into input field 228, via input unit 116B. As described herein, the inputted username and password combination may be communicated, by intermediary application 114, along with a request to link or access a distributed ledger, such as distributed ledger 113, to wallet application 112. Executed wallet application 112 may utilize the inputted user name and password combination to determine or verify the inputted user name and password combination is correct (e.g., the username or e-mail and password combination are correct). Upon executed wallet application 112 determining or verifying the inputted user name and password combination is correct, executed wallet application 112 may allow executed intermediary application 114 to link with executed wallet application 112 and access distributed ledger 113.

Referring back to FIG. 2A, and in some examples, user 201 may provide input 202 that identifies one or more digital assets to track and monitor. In some instances, executed intermediary application 114 may identify all digital tokens, such as non-fungible tokens, included in distributed ledger 113 of user 201, and user 201 may select one or more of the identified digital tokens. Given that each digital token is associated with a digital asset, each selected digital token may indicate to intermediary application 114 to track and monitor the usage of the corresponding digital asset by one or more third party users (e.g. users of a DSP computing system 120). For instance, executed intermediary application 114 and executed wallet application 112, described herein, may be linked. Additionally, while executed intermediary application 114 and executed wallet application 112 are linked, executed intermediary application 114 may access and identify, from distributed ledger 113 via wallet application 112, an identifier of each digital token, such as a non-fungible token, that indicates an ownership of a particular digital asset by a particular user (e.g. user 201). Based on the identified digital tokens, intermediary application 114 may generate and route one or more interface elements 204 to display unit 116A. Moreover, when rendered for presentation within a digital interface 214 by display unit 116A, the one or more interface elements 204 may graphically represent each of the identified digital tokens. Further, each of the interface elements 204 may be configured to be selectable, and, for each selected interface element 204, executed intermediary application 114 may obtain a corresponding identifier of the corresponding digital token and generate request 206 that includes the corresponding identifier of the corresponding digital token. Executed intermediary application 114 may transmit request 206 to server 101A of intermediary computing system 101. In some instances, executed intermediary application 114 may include additional data/information such as, information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of client device 110 into request 206 along with the corresponding identifier of the corresponding digital token. As described herein, the device data may uniquely identify client device 110.

In other instances, executed intermediary application 114 may identify digital tokens, such as non-fungible tokens, include in distributed ledger 113 of user 201 that are also associated with one or more DSP computing systems, such as DSP computing system 120. In such instances, user 201 may select one or more of the identified digital tokens. Given that each digital token is associated with a digital asset, each selected digital token may indicate to intermediary application 114 to track and monitor the usage of the corresponding digital asset by one or more third party users. For instance, executed intermediary application 114 and executed wallet application 112, described herein, may be linked. Additionally, while executed intermediary application 114 and executed wallet application 112 are linked, executed intermediary application 114 may access and identify, from distributed ledger 113 via wallet application 112, each digital token, such as a non-fungible token, indicating an ownership of a particular digital asset by user 201. Moreover, executed intermediary application 114 may access and identify, from distributed ledger 113, an element, such as a smart contract element, associated with each identified digital token. Further, executed intermediary application 114 may parse each identified smart contract element of each identified digital token to determine which identified smart contract element includes information (e.g., an address) regarding a DSP computing system, such as DSP computing system 120, that may provide a corresponding digital asset to one or more third party users. Based on the identified digital tokens that are associated with a smart contract element that includes information regarding a DSP computing system, executed intermediary application 114 may generate and route one or more interface elements 204 to display unit 116A. Moreover, when rendered for presentation within a digital interface 214 by display unit 116A, the one or more interface elements 204 may graphically represent each of the identified digital tokens that are associated with the smart contract element that includes information regarding a DSP computing system. Further, each of the interface elements 204 may be configured to be selectable. For each selected interface element 204, executed intermediary application 114 may obtain a corresponding identifier of the corresponding digital token and generate request 206 that includes the corresponding identifier of the corresponding digital token. Executed intermediary application 114 may transmit request 206 to server 101A of intermediary computing system 101. In some instances, executed intermediary application 114 may include additional data/information such as, information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of client device 110 into request 206 along with the corresponding identifier of the corresponding digital token. As described herein, the device data may uniquely identify client device 110.

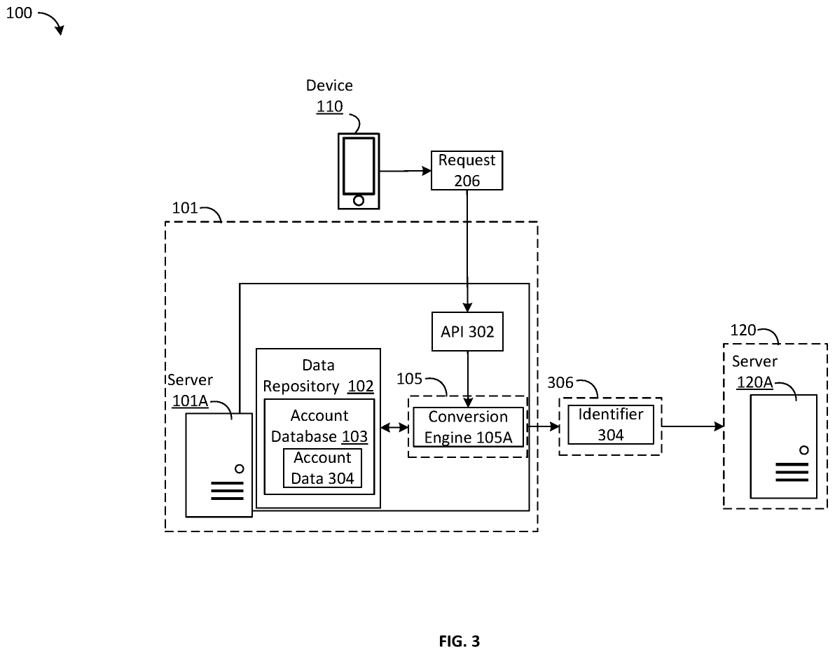

Referring to FIG. 3, a programmatic interface established and maintained by server 101A of intermediary computing system 101, such as application programming interface (API) 302, may receive request 206 that includes an identifier of a digital token. In some instances, request 206 may include device data of client device 110. Additionally, or alternatively, request 206 may include information identifying and characterizing the digital asset, such as one or more unique properties of the digital asset (e.g., wave form, tempo, file name, etc.). As described herein, intermediary computing system 101 may receive request 206 across communications network 140 via a channel of communications established programmatically between API 302 and executed intermediary application 114. Moreover, API 302 may route request 206 to executed conversion engine 105A. Executed conversion engine 105A may parse request 206, obtain the identifier of the digital asset, and in some instances, device data of client device 110 and/or information identifying and characterizing the digital asset. Further, executed conversion engine 105A may store the identifier of the digital asset and device data and/or information identifying and characterizing the digital asset within a corresponding portion of data repository 102, such as account database 103 into one or more portions of account data 103A.

As described herein, executed conversion engine 105A may perform operations that generate and transmit a DSP computing system compatible identifier based on an identifier of a digital token included in distributed ledger 113. For example, as illustrated in FIG. 3, executed conversion engine 105A may access account database 103 and parse account data 103A to obtain an identifier of a particular digital token that indicates ownership of a particular digital asset. Additionally, executed conversion engine 105A may generate DSP computing system compatible identifier 304 based on the obtained identifier of the particular digital token. Further, executed conversion engine 105A may generate message 306, package into one or more portions of message 306 the identifier of the particular digital token, and transmit message 306 to DSP computing system 120. In some instances, executed conversion engine 105A may store DSP computing system compatible identifier 304. In other instances, executed conversion engine 105A may include information identifying and characterizing an associated digital asset. In such instances, executed conversion engine 105A may access account database 103 and parse account data 103A to identify and obtain information identifying and characterizing a digital asset associated with the identifier of the particular digital token. Additionally, executed conversion engine 105A may package into one or more portions of message 306, the identifier of the particular digital token and the information identifying and characterizing a digital asset associated with the identifier of the digital token.

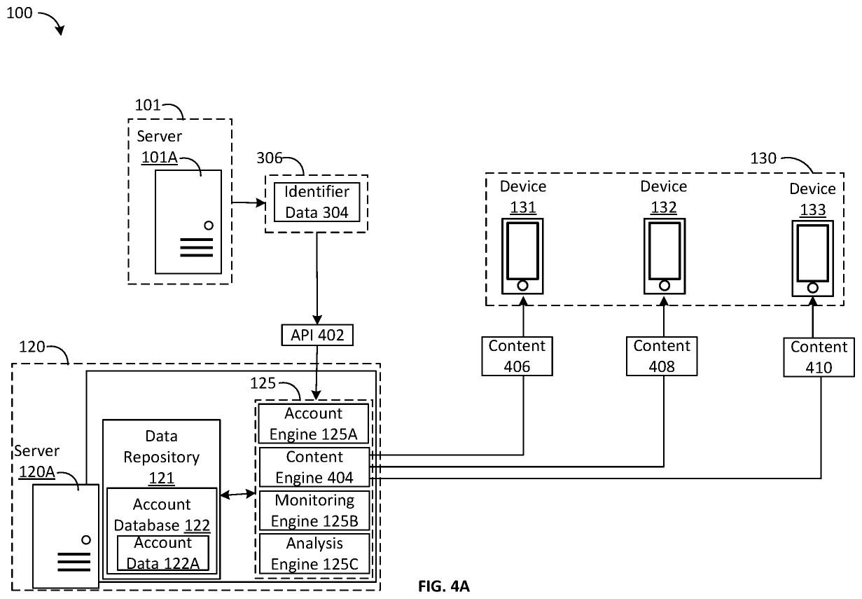

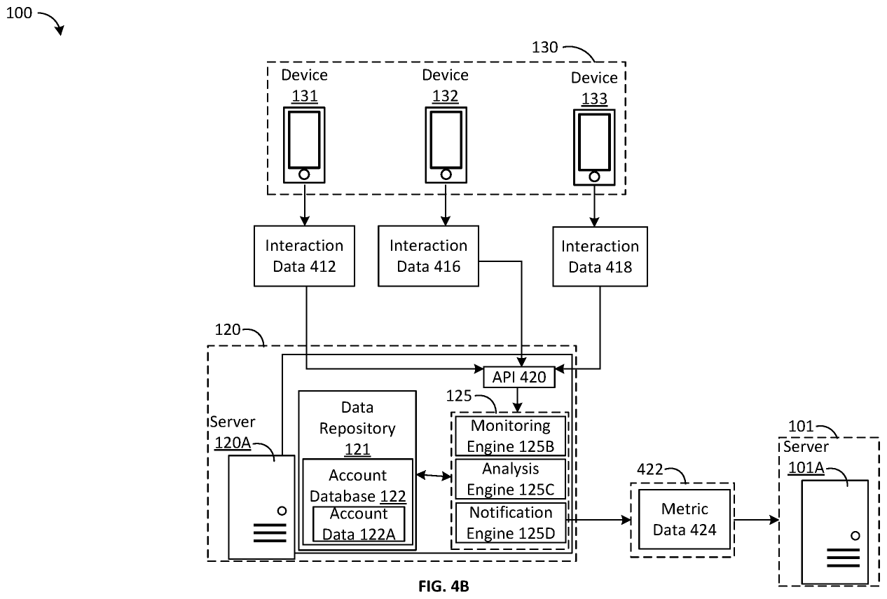

Referring to FIG. 4A, a programmatic interface established and maintained by server 120A of DSP computing system 120, such as API 402, may receive message 306 that includes a DSP computing system compatible identifier 304. In some instances, message 306 may include information identifying and characterizing a digital asset (e.g., the one or more unique properties of the digital asset) associated with a digital token that the DSP computing system compatible identifier 304 is associated with. As described herein, DSP computing system 120 may receive message 306 across communications network 140 via a channel of communications established programmatically between API 402 and executed conversion engine 105A. Moreover, API 402 may route message 306 to executed account engine 125A. Executed account engine 125A may parse message 306, obtain DSP computing system compatible identifier 304, and in some instances, the information identifying and characterizing the digital asset of the digital token associated with the DSP computing system compatible identifier 304. Further, executed account engine 125A may store DSP computing system compatible identifier 304 and information identifying and characterizing the digital asset within a corresponding portion of data repository 121, such as account database 122 into one or more portions of account data 122A.

In some examples, executed account engine 125A may generate an account profile in account data 122A based on and in response to receiving message 306. The account profile may be associated with user 201 of distributed ledger 113, and corresponding digital token from which DSP computing system compatible identifier 304 is generated. In some instances, executed account engine 125A may store the obtained DSP computing system compatible identifier 304 within the corresponding generated account profile stored in account database 122. In other instances, executed account engine 125A may store the information identifying and characterizing an associated digital asset within the corresponding generated account profile stored in account database 122.

Additionally, executed monitoring engine 125B may perform operations to track and monitor the usage of a digital asset associated with a particular DSP computing system compatible identifier 304. For example, as illustrated in FIG. 4A, executed monitoring engine 125B may access an account profile associated with user 201 stored in account data 122A. Additionally, executed monitoring engine 125B may obtain, from the account profile of user 201, a DSP computing system compatible identifier 304, along with information identifying and characterizing an associated digital asset.

Moreover, executed monitoring engine 125B may perform operations to track and monitor the usage of the associated digital asset, such as the usage of music content of the digital asset, by one or more third party users. As described herein and not illustrated in FIG. 4, DSP computing system 120 may support and maintain a DSP application program (not illustrated in FIG. 1) that may be executed by one or more processors of each of the one or more third party devices 130. Additionally, the one or more processors of server 120A may execute content engine 404 to provide content (e.g., music content) of one or more digital assets of various users of distributed ledgers, such as distributed ledger 113, to the executed DSP application program. The one or more third party users may interact with the content using the executed DSP application program. For example, referring to FIG. 4A, content engine 404 may provide music content 406 of a digital asset associated with a DSP computing system compatible identifier 304 to one or more third party devices 130 of one or more third party users, such as third party device 131, third party device 132, and third party device 133. Additionally, third party users operating the one or more third party devices 130 may interact with music content 406 using the executed DSP application program. Examples of interactions the executed DSP application program may enable a corresponding third party user to implement with the music content include, playing or streaming the music content, indicating whether the third music content is liked, indicating the number of times the music content was played or skipped, and a number of times the music content was added to a list, such as a play list.

Further, the executed DSP application program may be configured to generate interaction data indicating and characterizing the one or more interactions between the corresponding third party user and the content provided to the third party device 130 of the corresponding third party user. In some instance, the interaction data may further include a time stamp of the occurrence of each interaction and/or information identifying and characterizing the digital asset of the interacted with music content. Referring to FIG. 4B, executed DSP application program of third party device 131 may generate interaction data 412, executed DSP application program of third party device 131 may generate interaction data 414, and executed DSP application program of third party device 131 may generate interaction data 416. Interaction data 412, 414, 416 may each indicate and characterize one or more interactions between a third party user of the corresponding third party device 130 and the content provided to the corresponding third party device 130, and in some instances, a time stamp of the occurrence of each interaction and/or information identifying and characterizing the digital asset of the interacted with music content. Each of the third party devices 130 of the one or more third party users (e.g., third party device 131, third party device 132, d third party device 133) may transmit corresponding interaction data (e.g. interaction data 412, interaction data 414 and interaction data 416) to server 120A. As illustrated in FIG. 4B, a programmatic interface established and maintained by server 120A of DSP computing system 120, such as API 420, may receive interaction data 412 from executed DSP application program of third party device 131, interaction data 414 from executed DSP application program of third party device 132, and interaction data 416 from executed DSP application program of third party device 133. As described herein, DSP computing system 120 may receive interaction data, such as interaction data 412, interaction data 414 and interaction data 416, across communications network 140 via a channel of communications established programmatically between API 420 and an executed DSP application program of one or more third party devices 130 of one or more third party users.

As described herein, API 420 may route the interaction data (e.g., interaction data 412, interaction data 414 and interaction data 416) to executed monitoring engine 125B. Executed monitoring engine 125B may parse the interaction data to obtain data characterizing and identifying the interactions, a time stamp of the occurrence of each interaction and information identifying and characterizing the digital asset of the interacted with content. Additionally, executed monitoring engine 125B may identify a corresponding account profile included in account data 122A to store or link the obtained data (e.g., data characterizing and identifying the interactions, a time stamp of the occurrence of each interaction and information identifying and characterizing the digital asset of the interacted with content). For instance, based on the information identifying and characterizing the digital asset of the interacted with music content in the interaction data and the information identifying and characterizing a digital asset included in account profiles stored in account data 122A, executed monitoring engine 125B may identify an account profile in account data 122A where the information identifying and characterizing a digital asset included in the account profile matches with the information identifying and characterizing the digital asset of the interacted with music content in the interaction data. Additionally, executed monitoring engine 125B may store the data obtained (e.g., data characterizing and identifying the interactions, a time stamp of the occurrence of each interaction and information identifying and characterizing the digital asset of the interacted with content) from the interaction data, such as interaction data 412, interaction data 414 and interaction data 416, within a corresponding portion of data repository 121, such as account database 122 into one or more portions of account data 122A. In some instances, the obtained data (e.g., data characterizing and identifying the interactions, a time stamp of the occurrence of each interaction and information identifying and characterizing the digital asset of the interacted with content) may be stored in the identified account profile or include data that identifies the identified account profile.

As illustrated in FIG. 4B, executed analysis engine 125C may perform operations as described herein to generate metric data, such as metric data 424, for each account profile in account data 122A. As described herein, the metric data may include one or more metrics associated with the usage of content of a digital asset by one or more third parties or interactions of the content of the digital asset by one or more third party devices 130 of the one or more third parties. By way of example, executed analysis engine 125C may, for an account profile associated with user 201 of client device 110 and from account database 122, data characterizing and identifying the interactions between one or more third party users and content of an associated digital asset, a time stamp of the occurrence of each interaction and information identifying and characterizing the digital asset of the interacted with content. Additionally, executed analysis engine 125C may generate metric data 424 based on the data characterizing and identifying the interactions between one or more third party users and content of an associated digital asset, a time stamp of the occurrence of each interaction and/or information identifying and characterizing the digital asset of the interacted with content.

In some instances, executed analysis engine 125C may generate metric data 424 that includes one or more metrics that aggregate the interactions during a particular time interval. In such instances, a request for metric data or for tracking and monitoring a particular digital asset transmitted by intermediary computing system 101 and received by DSP computing system 120, may include a timing parameter. The timing parameter may indicate the time interval (e.g., previous thirty days from the date of receipt of the request). For instance, intermediary computing system 101 may be configured to transmit a request for metric data (or for tracking and monitoring a particular digital asset), to DSP computing system 120, periodically—every month. The timing parameter of the request may indicate a time interval for the requested metric data. In response to and based on the request, In response to and based on the request, DSP computing system 120 may transmit metric data, such as metric data 424, to intermediary computing system 101 in accordance with the periodic time interval included in the request (e.g., every thirty days). Further, executed monitoring engine 125B may generate metric data, such as metric data 424, that includes one or more metrics that identify and characterize the aggregate interactions of the indicated time interval (e.g., the past 30 days from the date of receipt of the request). Examples of the one or metrics include a number of times the content of the digital asset was liked in the thirty-day time interval; a number of times the content of the digital asset was interacted within the thirty-day time interval (e.g., number of times a music content of the digital asset was played or skipped during the thirty-day time interval), and/or a number of times the content of the digital asset was added to a list (e.g., a play list) within the thirty-day time interval. In some instances, executed analysis engine 125C may store the generated metric data 424 in a corresponding account profile in account data 122A that stored the interaction data of which the metric data was based off.

Referring back to FIG. 4B, executed notification engine 125D may transmit the generated metric data, such as metric data 424 to intermediary computing system 101. For example, executed notification engine 125D may access account database 122 and parse account data 122A to identify an account profile associated with user 201. Additionally, executed notification engine 125D may obtain, from account data 122A, metric data 424 associated with the account profile of user 201. Moreover, executed notification engine 125D may generate message 422 and package one or more portions of metric data 424 into message 422. Further, executed notification engine 125D may also identify a corresponding DSP computing system compatible identifier from account data 122A and package the DSP computing system compatible identifier into message 422. In some instances, executed notification engine 125D may, as described herein and for each of one or more account profiles, generate a message and package into portions of the message one or more portions of metric data of the corresponding account profile. Additionally, executed notification engine 125D may transmit message 422 to intermediary computing system 101.

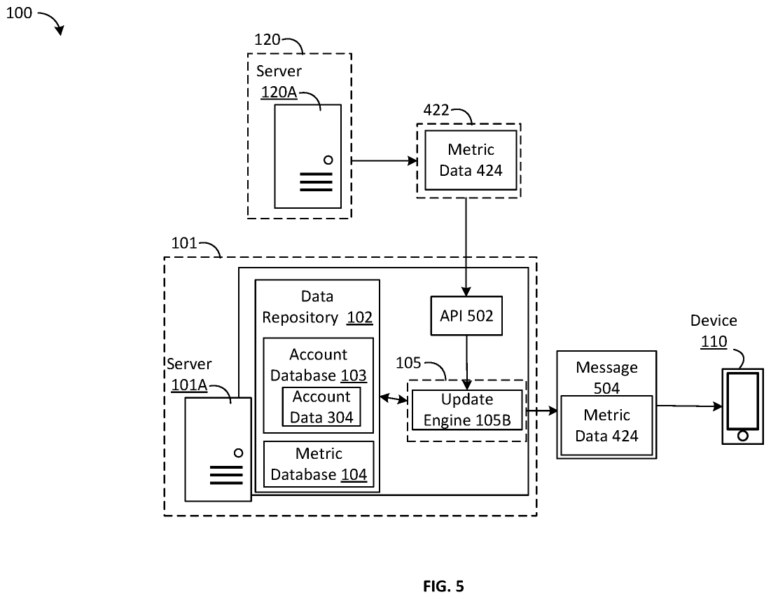

Referring to FIG. 5, intermediary computing system 101 may receive message 422 including metric data 424 and the associated DSP computing system compatible identifier. Additionally, intermediary computing system 101 may receive message 422 across communications network 140 via a channel of communications established programmatically between API 502 and executed notification engine 125D of DSP computing system 120. As illustrated in FIG. 5, API 502 may route message 422 to executed update engine 105B and executed update engine 105B may perform operations that obtain message 422 and obtain metric data 424 from message 422. Additionally, executed update engine 105B may store metric data 424 into corresponding portions of data repository 102, such as metric database 104.

In some examples, executed update engine 105B may process metric data 424 to include data identifying or linking portions of metric data 424 to the identified portions of account data 122A. For example, executed update engine 105B may access account database 122 to identify portions of account data 122A associated with DSP computing system compatible identifier included in message 422. Based on the identified portions of account data 122A, executed update engine 105B may generate data indicating or linking the identified portions of account data 122A to the portions of metric data 424 included in message 422. Executed update engine 105B may store the data indicating or linking the identified portions of account data 122A to the portions of metric data 424 included in message 422 into metric database 104. As described herein, metric data 424 may include mutable and immutable type data.

Moreover, executed update engine 105B may transmit one or more portions of metric data 424 stored in metric database 104 to executed intermediary application 114 of client device 110. In some examples, executed update engine 105B may obtain metric data 424 from metric database 104. Additionally, based on metric data 424, executed update engine 105B may obtain, from metric database 104, data indicating or linking the identified portions of account data 122A to the portions of metric data 424. Based on the data indicating or linking the identified portions of account data 122A, executed update engine 105B may parse account data 103A of account database 103 to identify the portions of account data 122A associated with metric data 424. Based on the identified portions of account data 122A associated with metric data 424, executed update engine 105B may obtain a DSP computing system compatible identifier and an identifier of the digital token. The digital token may be associated with the digital asset metric data 424 (e.g., the usage of the digital asset of the digital token). Based at least on the identifier of the digital token obtained from the identified one or more portions of account data 122A associated with metric data 424, executed update engine 105B may generate message 504 and package one or more portions of metric data 424 into message 504. Additionally, executed update engine 105B may transmit message 504 to client device 110. In some instances, executed update engine 105B may obtain device data of client device 110 from the identified portions of account data 122A associated with metric data 424. Based at least on the device data of client device 110 and/or the identifier of the digital token obtained from the identified one or more portions of account data 122A associated with metric data 424, executed update engine 105B may determine which client device is to receive message 504.

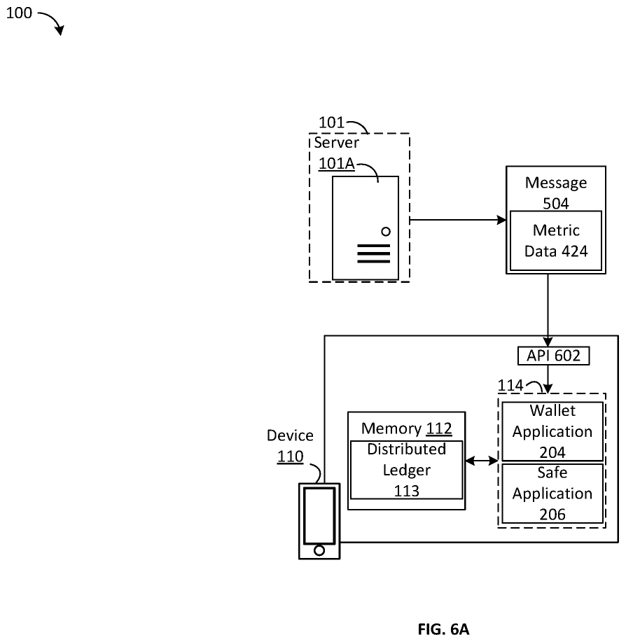

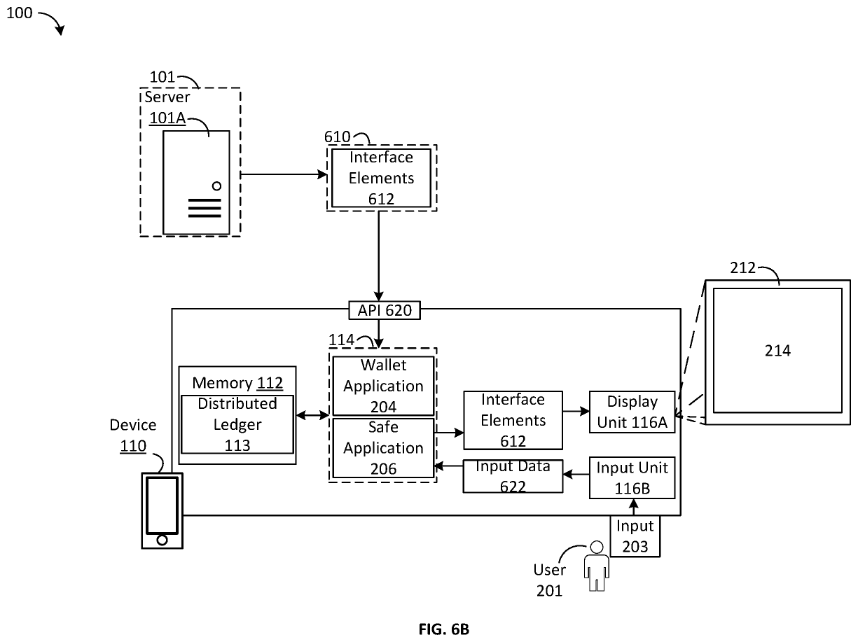

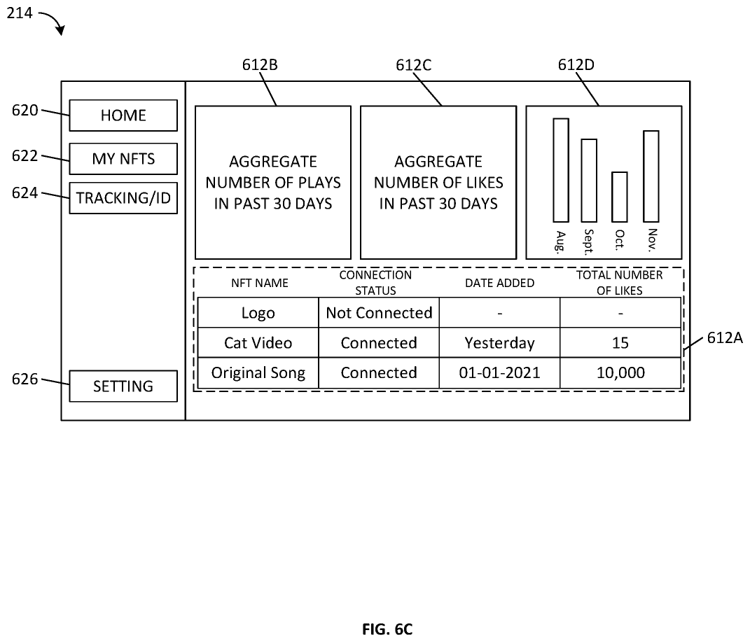

Referring to FIG. 6A, client device 110 may receive message 504 including metric data 424. Additionally, client device 110 may receive message 504 across communications network 140 via a channel of communications established programmatically between API 602 and executed update engine 105B of intermediary computing system 101. As illustrated in FIG. 6A, API 502 may route message 504 to executed intermediary application 114 and executed intermediary application 114 may perform operations that obtain message 504, parse message 504 and obtain the one or more portions of metric data 424 from message 504. Additionally, executed intermediary application 114 may store the one or more portions of metric data 424 into corresponding portions of memory 111.

In some examples, executed wallet application 112 may cause client device 110 to perform operations that record the one or more portions of metric data 424 within at least one element of distributed ledger 113. In some instances, executed wallet application 112 may perform additional operations that cause client device 110 to record portions of metric data 424 that are mutable relative to the digital asset. For example, a digital asset associated with metric data 424 may be music content. Additionally, portions of metric data 424 may include immutable type data, such as the wave form and tempo of the music content, and mutable type data, such as data characterizing a number of indications the digital asset was liked, a number of times the digital asset was interacted with, and/or a number of times the digital asset was added to a list associated with an account of at least one of the one or more additional devices. Moreover, executed wallet application 112 may identify which of the portions of metric data 424 include immutable type data and which of the portions of metric data 424 include mutable type data. Further, wallet application 112 may cause the client device 110 to record portions of metric data 424 that are mutable within at least one element of the distributed ledger 113.

In some instances, the elements of the distributed ledger 113 that include portions of metric data, such as metric data 424, that are mutable may also include immutable data such as information or data identifying the corresponding digital token and/or digital asset. For instance, the elements of the distributed ledger 113 that include portions of metric data 424 of a particular digital asset may include data identifying and characterizing a name of the digital token, a token symbol, and/or a unique identifier associated with the digital token. Additionally, or alternatively, the elements of the distributed ledger 113 that includes portions of metric data 424 of the particular digital asset may include data identifying and characterizing a unique identifier associated with the corresponding smart contract, and/or unique properties of the corresponding digital asset.

In some examples, executed intermediary application 114, may perform operations, described herein, to generate and render for presentation at a computing device of a user, such as client device 110, a digital interface, such as an interactive digital dashboard, having one or more tracker interface elements that identify, for each digital token of the user, one or more metrics of a corresponding digital asset. Referring to FIG. 6B, subsequent to executed wallet application 112 recording the one or more portions of metric data 424 within at least one element of distributed ledger 113, executed intermediary application 114 may communicate with executed wallet application 112 to identify, for each of the one or more digital tokens included in distributed ledger 113, one or more elements of distributed ledger 113 that includes one or more portions of metric data, such as metric data 424 obtained from DSP computing systems, such as DSP computing system 120. In such an example, executed intermediary application 114 may parse through each element of distributed ledger 113 to determine, for each of the one or more digital tokens, which of the elements that includes the one or more portions of metric data and is associated with the corresponding digital token based on information or data identifying a digital token and/or corresponding digital asset. Additionally, executed intermediary application 114 may obtain, for each of the one or more digital tokens, metric data, such as metric data 424, associated with each of the one or more digital tokens. Further, executed intermediary application 114 may generate, for each of the one or more digital tokens, one or more tracker interface elements 612 of the digital interface (e.g., an interactive digital dashboard) based on the one or more portions of metric data of each of the one or more digital tokens. When rendered for presentation within the digital interface 214 by display unit 116A, one or more track interface elements 612 may graphically represent the usage of the corresponding digital asset.

In some instances, tracker interface elements 612 may provide a graphical representation of the most current metrics of a digital asset of a particular digital token. In other instances, tracker interface elements 612 may provide a graphical representation of historical data characterizing trends of each of the metrics of the corresponding digital asset of a particular digital token during a current temporal interval and over one or more prior temporal intervals. In various instances, digital interface 214 may include, for one or more metrics of the corresponding digital asset of each of the one or more digital tokens, a graphical representation of an aggregate value of the associated metric during the current temporal interval and across and one or more prior temporal intervals.

FIG. 6C illustrates an example digital interface (e.g., an interactive digital dashboard) 214 including tracker interface elements 612, such as tracker interface elements 612A, tracker interface elements 612B, tracker interface elements 612C, tracker interface elements 612D, and additional interface elements, such as interface elements 620, interface elements 622, interface elements 624, interface elements 626 that enable a user, such as user 201, to navigate the digital interface. As illustrated in FIG. 6C, tracker interface element 612A may graphically represent a table or list of digital tokens (e.g., non-fungible tokens) that intermediary application 114 has identified, as described herein. Additionally, tracker interface element 612A may also identify which of the identified digital tokens and corresponding digital asset is being tracked or monitored (e.g., connection status—not connected or connected), a corresponding identifier or name of the digital asset, a corresponding date intermediary application 114 initiated tracking and monitoring the usage of the corresponding digital asset (e.g., “date added”) and a corresponding metric (e.g., “total number of likes”). Additionally, tracker interface elements 612B, 612C and 612D, when presented and displayed on digital interface 214, may each graphically represent a particular metric for one of the digital assets being tracked. For instance, as illustrated in FIG. 6C, tracker interface elements 612B, 612C and 612D may each be associated with the digital asset identified or named as “original song.” Moreover, tracker interface element 612B may graphically represent the metric associated with the aggregate number of times “original song” was played by one or more third party users via a corresponding third party device 130, and tracker interface element 612C may graphically represent the metric associated with the aggregate number of times one or more third party users indicated they liked “original song,” via a corresponding third party device 130. Further, tracker interface element 612D may graphically represent the metric associated with the aggregate number of times one or more third party users played “original song,” via a corresponding third party device 130 each month for the past 4 months.

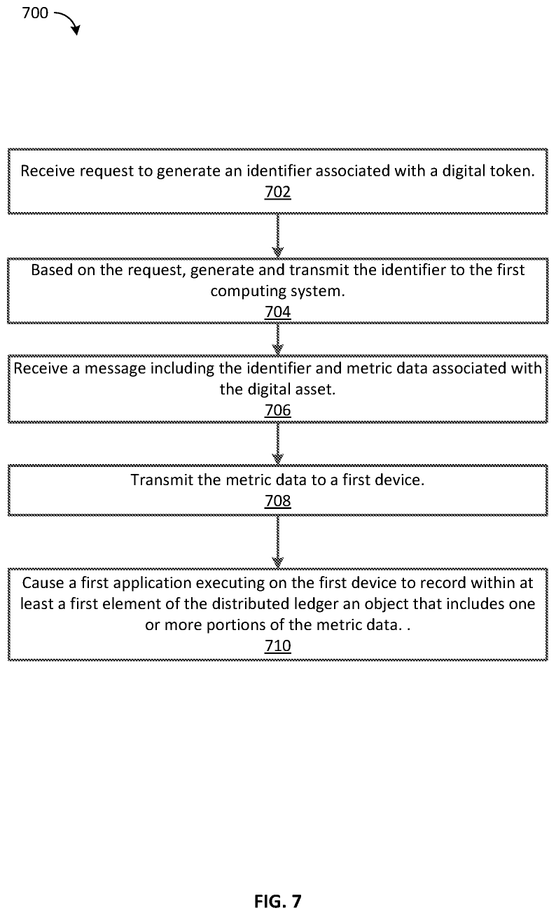

FIG. 7 is a flowchart of an exemplary process 700 for tracking and monitoring usage of a digital asset of a distributed ledger, such as distributed ledger 113. For example, one or more computing systems, such as intermediary computing system 101, may perform one or more steps of exemplary process 700, as described below in reference to FIG. 7. Referring to FIG. 7, intermediary computing system 101 may perform any of the processes described herein to receive request 206 to generate an identifier associated with a digital token (e.g., in step 702 of FIG. 7). In some examples, the digital token, such as a non-fungible token (e.g., ERC-721 token), may be associated with an immutable digital asset and an immutable smart contract object of a distributed ledger. Additionally, request 206 may be generated and transmitted from executed intermediary application 114 of client device 110. In some instances, request 206 may include additional data/information such as, information or an address of one or more DSP computing systems, such as DSP computing system 120, that may provide the corresponding digital asset to one or more third party devices 130, information identifying and characterizing the digital asset, such as one or more unique properties of the digital asset (e.g., wave form, tempo, file name, etc.), and/or device data of client device 110, along with the request.

Additionally, intermediary computing system 101 may perform any of the processes described herein to generate and transmit the identifier of the digital token to a first computing system (e.g., in step 704 of FIG. 7), such as DSP computing system 120. In some examples, intermediary computing system 101 may generate and transmit the identifier or DSP computing system compatible identifier to the first computing system based on the request. Additionally, intermediary computing system 101 may generate and transmit the identifier to the first computing system in response to a confirmation that the request was made by or for an owner of the digital asset (e.g. user 201, user of client device 110). For example, executed conversion engine 105A may generate the identifier or DSP computing system compatible identifier 304 based on the obtained identifier of the particular digital token. Additionally, executed conversion engine 105A may generate the identifier or DSP computing system compatible identifier 304 in response to a user, such as user 201 (e.g., an owner of the digital asset associated with the digital token), selecting an interface element on a digital interface (e.g., digital interface 214) that graphically represents the particular digital token. Further, executed conversion engine 105A may generate message 306, package into one or more portions of message 306 the identifier of the particular digital token, and transmit message 306 to DSP computing system 120. In some instances, executed conversion engine 105A may include information identifying and characterizing an associated digital asset.

Moreover, intermediary computing system 101 may perform any of the processes described herein to receive a message including the identifier and metric data associated with the digital asset (e.g., in step 706 of FIG. 7). As described herein, the metric data may identify and characterize one or more metrics associated with one or more interactions of the digital asset by one or more additional devices (e.g., one of more third party devices 130). Additionally, the metric data may be formatted into a JSON format. In some examples, intermediary computing system may receive a message, such as message 422, including metric data, such as metric data 424. In such examples, executed update engine 105B may parse the message and obtain the metric data. In some instances, executed update engine 105B may process metric data to include data identifying or linking portions of metric data 424 to associated portions of account data 122A. For instance, executed update engine 105B may access account database 122 to identify portions of account data 122A associated with DSP computing system compatible identifier included in message 422. Based on the identified portions of account data 122A, executed update engine may generate data indicating or linking the identified portions of account data 122A to the portions of metric data 424 included in message 422. Executed update engine 105B may store the data indicating or linking the identified portions of account data 122A to the portions of metric data 424 included in message 422 into metric database 104. As described herein, metric data 424 may include mutable and immutable type data.

Further, intermediary computing system 101 may perform any of the processes described herein to transmit the metric data to the first device (e.g. device of user 201, client device 110) based at least on the identifier included in the message (e.g., in step 708 of FIG. 7), and cause a first application program executing on the first device to record, within at least a first element of the distributed ledger, an object that includes one or more portions of the metric data (e.g., in step 710 of FIG. 7). In some examples, executed update engine 105B may transmit, one or more portions of metric data to an executed intermediary application of a client device (e.g. device of user 201, client device 110). For instance, executed update engine 105B may obtain, from metric database 104, data indicating or linking the identified portions of account data 122A to the portions of metric data obtained from intermediary computing system 101. Based on the data indicating or linking the identified portions of account data 122A, executed update engine 105B may parse account data 103A of account database 103 to identify the portions of account data 122A associated with the metric data. Based on the identified portions of account data 122A associated with the metric data, executed update engine 105B may obtain a DSP computing system compatible identifier and an identifier of the digital token. The digital token may be associated with the digital asset to which the metric data is related (e.g., the usage of the digital asset of the digital token). Based at least on the identifier of the digital token obtained from the identified one or more portions of account data 122A associated with the metric data, executed update engine 105B may generate a message, such as message 504 and package one or more portions of the metric data into the message. Additionally, executed update engine 105B may transmit the message to the client device (e.g. device of user 201, client device 110). In some instances, executed update engine 105B may obtain device data of a client device from the identified portions of account data 122A associated with metric data 424. Based at least on the device data of the client device and/or the identifier of the digital token obtained from the identified one or more portions of account data 122A associated with the metric data, executed update engine 105B may determine which client device is to receive the message.

Additionally, the executed intermediary application of the computing device may receive the message from intermediary computing system 101 that includes the metric data generated and transmitted from a corresponding DSP computing system, such as DSP computing system 120. Moreover, an executed wallet application of the computing device may cause the client device to perform operations, as described herein, that record the one or more portions of the metric data within at least one element of a distributed ledger associated with a user operating the client device (e.g. user 201, user of client device 110).

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including conversion engine 105A, updated engine 105B, wallet application 112, intermediary application 114, account engine 125A, monitoring engine 125B, analysis engine 125C, notification engine 125D, application programming interface (API) 302, API 402, API 420, API 502, API 602, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, an application program, an engine, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed:

1. An apparatus, comprising:
a communications interface;
a memory storing instructions; and
at least one processor coupled to the communications interface and to the memory, the at least one processor being configured to execute the instructions to:
receive, from a first device via the communications interface, a request to generate an identifier associated with a digital token, the digital token being associated with an immutable digital asset and an immutable smart contract object of a distributed ledger;
based on the request, and confirmation that the request was made by or for an owner of the digital asset, generate and transmit, via the communications interface and to a first computing system, the identifier;
receive, via the communications interface and from the first computing system, a message including the identifier and metric data associated with the digital asset, the metric data identifying and characterizing one or more metrics associated with one or more interactions of the digital asset by one or more additional devices via the first computing system; and
based at least on the identifier included in the message, transmit, via the communications interface and to the first device, the metric data; and
cause a first application program executing on the first device to record, within at least a first element of the distributed ledger, an object that includes one or more portions of the metric data.

2. The apparatus of claim 1, wherein the at least one processor is further configured to:
cause the first application program executing on the first device to present a graphical representation of at least one of the one or more metrics within a digital interface.

3. The apparatus of claim 2, wherein the at least one processor causes the first application program executing on the first device to present the graphical representation of at least one of the one or more metrics within the digital interface based on the recordation of the object that includes the one or more portions of the metric data.

4. The apparatus of claim 3, wherein the first application program is maintained by the apparatus.

5. The apparatus of claim 4, wherein the first application program maintained by the apparatus accesses one or more objects of the distributed ledger through a decentralized application program executing on the first device.

6. The apparatus of claim 5, wherein the one or more objects may include data of previously recorded one or more portions of previously obtained metric data.

7. The apparatus of claim 1, wherein the first computing system is further configured to:
monitor the one or more interactions of the digital asset by one or more users, other than the digital asset owner, of the one or more additional devices and via the first computing system; and
generate the metric data.

8. The apparatus of claim 1, wherein the distributed ledger includes one or more smart contract objects, each of the one or more smart contract objects includes at least one element identifying a particular computing system.

9. The apparatus of claim 8, wherein the at least one processor is further configured to identify one or more computing systems based on each of the one or more smart contract objects of the distributed ledger, the one or more computing systems including the first computing system.

10. The apparatus of claim 1, wherein the first computing system is further configured to present at least a portion of the digital asset within a digital interface of at least one of the one or more additional devices.

11. The apparatus of claim 1, wherein the digital asset includes at least one of music content, video content, imaging content, gaming content, and document content.

12. The apparatus of claim 1, wherein the digital token is a non-fungible token.

13. The apparatus of claim 11, wherein the digital asset is music content, and wherein the one or more metrics includes at least one of a number of indications the digital asset was liked, a number of times the digital asset was interacted with, a number of times the digital asset was added to a list associated with an account of at least one of the one or more additional devices, wave form and tempo.

14. The apparatus of claim 1, wherein the digital asset is stored in a database.

15. The apparatus of claim 1, wherein the digital asset is stored in an object included in the distributed ledger.

16. A computer-implemented method, comprising:
receiving, using at least one processor and from a first device, a request to generate an identifier associated with a digital token, the digital token being associated with an immutable digital asset and an immutable smart contract object of a distributed ledger;
based on the request, and confirmation that the request was made by or for an owner of the digital asset, generating and transmitting, using the at least one processor and to a first computing system, the identifier;
receiving, using the at least one processor and from the first computing system, a message including the identifier and metric data associated with the digital asset, the metric data identifying and characterizing one or more metrics associated with one or more interactions of the digital asset by one or more additional devices via the first computing system;
based at least on the identifier included in the message, transmitting, using the at least one processor and to the first device, one or more portions of the metric data; and
causing a first application program executing on the first device to present a graphical representation of at least one of the one or more metrics within a digital interface.

17. The computer-implemented method of claim 16, further comprising:
causing the first application program executing on the first device to record, within at least a first element of the distributed ledger, an object that includes one or more portions of the metric data.

18. The computer-implemented method of claim 17, wherein the causing the first application program executing on the first device to present the graphical representation of the at least one of the one or more metrics within the digital interface is based on the recordation of the object that includes the one or more portions of the metric data.

19. The computer-implemented method of claim 18, wherein the first application program is maintained by the at least one processor, and the at least one processor accesses one or more objects of the distributed ledger through a decentralized application program executing on the first device.

20. A non-transitory, machine-readable storage medium storing instructions that, when executed by at least one processor of a server, causes the at least one processor to perform operations that include:
receiving, from a first device, a request to generate an identifier associated with a digital token, the digital token being associated with an immutable digital asset and an immutable smart contract object of a distributed ledger;
based on the request, and confirmation that the request was made by or for an owner of the digital asset, generating and transmitting, to a first computing system, the identifier;
receiving, from the first computing system, a message including the identifier and metric data associated with the digital asset, the metric data identifying and characterizing one or more metrics associated with one or more interactions of the digital asset by one or more additional devices via the first computing system;
based at least on the identifier included in the message, transmitting, to the first device, one or more portions of the metric data; and
causing a first application program executing on the first device to record, within at least a first element of the distributed ledger, an object that includes one or more portions of the metric data.
